(19) United States
(12) Patent Application Publication
(10) Pub. No.: US 2014/0113603 A1
(43) Pub. Date: Apr. 24, 2014

(54) APPARATUS AND METHOD FOR PROVIDING SYMPATHY INFORMATION IN AN ELECTRONIC DEVICE

(71) Applicant: Samsung Electronics Co., Ltd., Gyeonggi-do (KR)

(72) Inventor: Jin PARK, Gyeonggi-do (KR)

(73) Assignee: Samsung Electronics Co., Ltd., Gyeonggi-do (KR)

(21) Appl. No.: 14/045,456

(22) Filed: Oct. 3, 2013

(30) Foreign Application Priority Data
Oct. 19, 2012 (KR) 10-2012-0116696

(51) Int. Cl. H04W 4/16

(52) U.S. Cl. CPC H04W 4/16
USPC 455/415; 455/566

(57) ABSTRACT

A method and apparatus are provided for outputting sympathy information in an electronic device. The method includes detecting a sympathy event associated with an opposite party terminal; retrieving sympathy information associated with the opposite party terminal; and outputting the sympathy information. The sympathy information includes at least one of an image, text, and content that is sharable by a user of the electronic device with a user of the opposite party terminal.

### PRIORITY

This application claims priority under 35 U.S.C. §119 to Korean Application Serial No. 10-2012-116696, which was filed in the Korean Intellectual Property Office on Oct. 19, 2012, the content of which is incorporated herein by reference.

### BACKGROUND OF THE INVENTION

1. Field of the Invention

The present invention relates generally to an electronic device, and in particular, to an apparatus and method for providing a user interface in an electronic device.

2. Description of the Related Art

A mobile electronic device provides a User Interface (UI) for smoothly performing interaction with a user. Typically, this UI is customized to a user (e.g., an owner) of the mobile electronic device.

In addition to being used merely as a personalized device for managing personal information, the mobile electronic device is also used to communicate with an opposite party, and exchange information among a plurality of users, e.g., with social network services. However, a personally customized UI of the mobile electronic device may not be set up for performing smooth communication with an opposite party.

### SUMMARY OF THE INVENTION

An aspect of the present invention is to substantially solve at least the above problems and/or disadvantages and to provide at least the advantages below.

Accordingly, an aspect of the present invention is to provide an apparatus and method for providing a UI in an electronic device.

Another aspect of the present invention is to provide an apparatus and method for providing a UI for communicating with an opposite party.

Another aspect of the present invention is to provide an apparatus and method for providing a UI for forming a bond of sympathy with an opposite party in an electronic device.

Another aspect of the present invention is to provide an apparatus and method for providing sympathy information according to call originating terminal information in an electronic device.

Another aspect of the present invention is to provide an apparatus and method for providing sympathy information based on position information in an electronic device.

In accordance with an aspect of the present invention, a method is provided for outputting sympathy information in an electronic device. The method includes detecting a sympathy event associated with an opposite party terminal; retrieving sympathy information associated with the opposite party terminal; and outputting the sympathy information. The sympathy information includes at least one of an image, text, and content that is sharable by a user of the electronic device with a user of the opposite party terminal.

In accordance with another aspect of the present invention, an electronic device is provided for outputting sympathy information. The electronic device includes a display unit; and a processor configured to detect a sympathy event associated with an opposite party terminal, retrieve sympathy information associated with the opposite party terminal, and output the sympathy information through the display unit. The sympathy information includes at least one of an image, text, and content that is sharable by a user of the electronic device with a user of the opposite party terminal.

### BRIEF DESCRIPTION OF THE DRAWINGS

The above and other aspects, features, and advantages of certain embodiments of the present invention will become more apparent from the following detailed description when taken in conjunction with the accompanying drawings, in which:

FIG. 1 illustrates an electronic device according to an embodiment of the present invention;

FIG. 2 illustrates a processor according to an embodiment of the present invention;

FIG. 3 is a flowchart illustrating a procedure for outputting sympathy information in an electronic device according to an embodiment of the present invention;

FIG. 4 is a flowchart illustrating a procedure for outputting sympathy information on a call originating electronic device according to an embodiment of the present invention;

FIGS. 5A to 5G illustrate examples of screen configurations for outputting sympathy information on a call originating terminal according to embodiments of the present invention;

FIG. 6 is a flowchart illustrating a procedure for generating a sympathy image in an electronic device according to an embodiment of the present embodiment;

FIG. 7 is a flowchart illustrating a procedure for outputting sympathy information based on position information in an electronic device according to an embodiment of the present invention;

FIGS. 8A to 8C illustrate examples of screen configurations for outputting sympathy information in consideration of position information according to embodiments of the present invention;

FIG. 9 is a flowchart illustrating a procedure for outputting sympathy information through a messenger application program in an electronic device according to an embodiment of the present invention;

FIGS. 10A to 10C illustrate examples of screen configurations for outputting sympathy information through a messenger application program according to embodiments of the present invention;

FIG. 11 is a flowchart illustrating a procedure for outputting sympathy information through a messenger application program according to an embodiment of the present invention;

FIGS. 12A to 12B illustrate examples of screen configurations for outputting sympathy information through a messenger application program according to embodiments of the present invention;

FIG. 13 is a flowchart illustrating a procedure for outputting sympathy information based on position information in an electronic device according to an embodiment of the present invention; and

FIGS. 14A to 14B illustrate examples of screen configurations for outputting sympathy information based on position information according to embodiments of the present invention.

### DETAILED DESCRIPTION OF EMBODIMENTS OF THE INVENTION

Various embodiments of the present invention will be described herein below with reference to the accompanying drawings. In the following description, detailed descriptions of well-known functions or constructions will be omitted to avoid obscuring the invention in unnecessary detail. Also, the terms used herein are defined according to the functions of the present invention. Thus, the terms may vary depending on user or operator intentions or practices. Therefore, the terms used herein must be understood based on the descriptions made herein.

For example, an electronic device, as described herein, may be a mobile communication terminal, a Personal Digital Assistant (PDA), a laptop computer, a smart phone, a net book computer, a television, a Mobile Internet Device (MID), an Ultra Mobile Personal Computer (UMPC), a tablet PC, a navigation device, or an MP3 player.

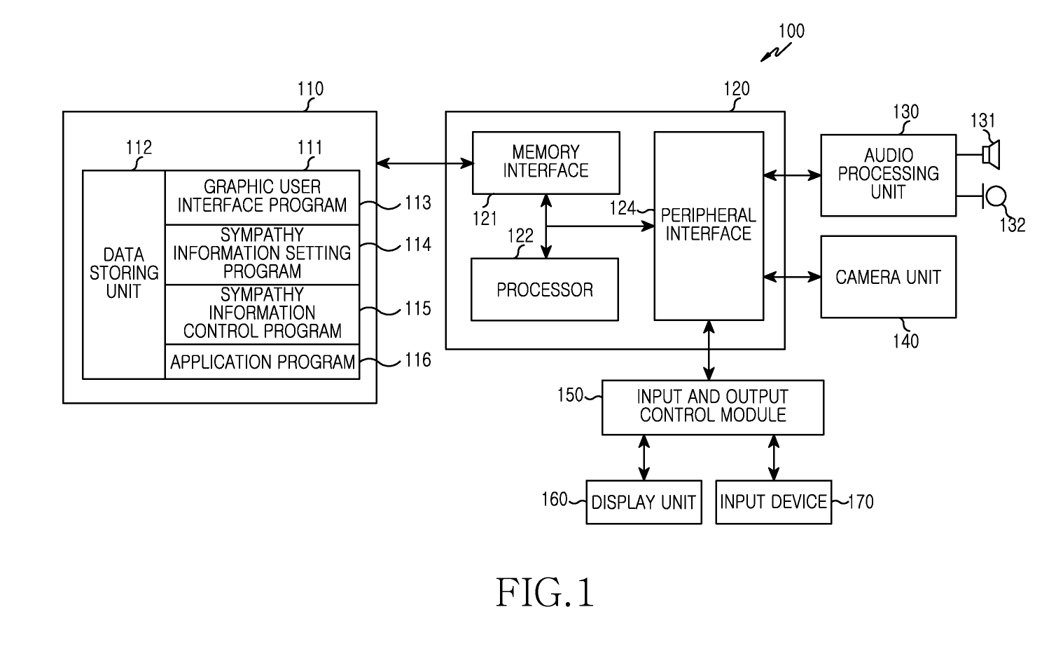

FIG. 1 illustrates an electronic device according to an embodiment of the present invention.

Referring to FIG. 1, the electronic device 100 includes a memory 110, a processor unit 120, an audio processing unit 130, a camera unit 140, an input and output controller 150, a display unit 160, and an input device 170. Although FIG. 1 illustrates a single memory 110, the electronic device 100 may include multiple memory devices.

The memory 110 includes a program storing unit 111 for storing programs for controlling operations of the electronic device 100, and a data storing unit 112 for storing data created during program execution.

The data storing unit 112 stores sympathy information determined by a sympathy information setting program 114, and extraction information for extracting sympathy information. For example, the sympathy information may include one or more of an image, a text, and content that a user may share with an opposite party. The extraction information may include at least one of reference image information for face recognition, and schedule information.

The program storing unit 111 includes a Graphic User Interface (GUI) program 113, a sympathy information setting program 114, a sympathy information control program 115, and at least one application program 116. Here, the programs stored in the program storing unit 111 are sets of instructions and may be represented as instruction sets.

The GUI program 113 includes at least one software element for providing a user interface graphically on the display unit 160. For example, the GUI program 113 may control application information driven by the processor 122 to be displayed on the display unit 160. For another example, the GUI program 113 may control sympathy information determined by the sympathy information control program 115 to be displayed on the display unit 160.

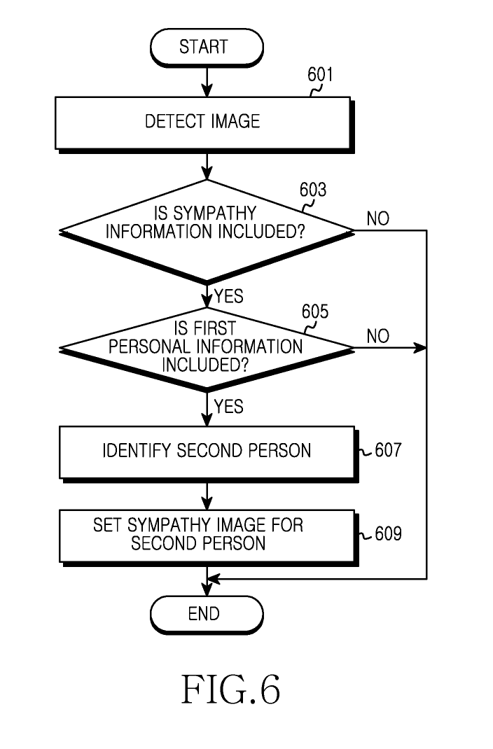

The sympathy information setting program 114 includes at least one software element for setting sympathy information. For example, the sympathy information setting program 114 may retrieve sympathy information set by a user according to a sympathy information setting event, or the sympathy information setting program 114 may, as will be described below with reference to FIG. 6, extract a sympathy image through face recognition for an image provided through the camera unit 140 or a network.

As another example, the sympathy information setting program 114 may create sympathy information in consideration of user schedule information. For example, when schedule information for watching a movie with friends is set, the sympathy information setting program 114 may create sympathy information for the friends based on information of the movie.

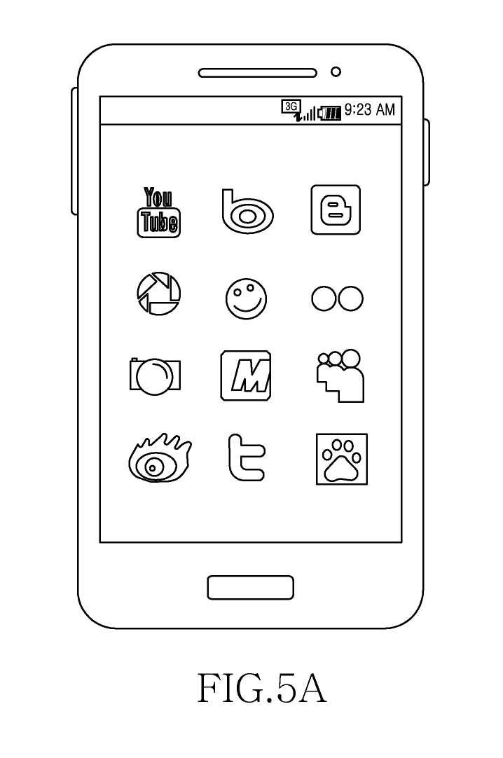

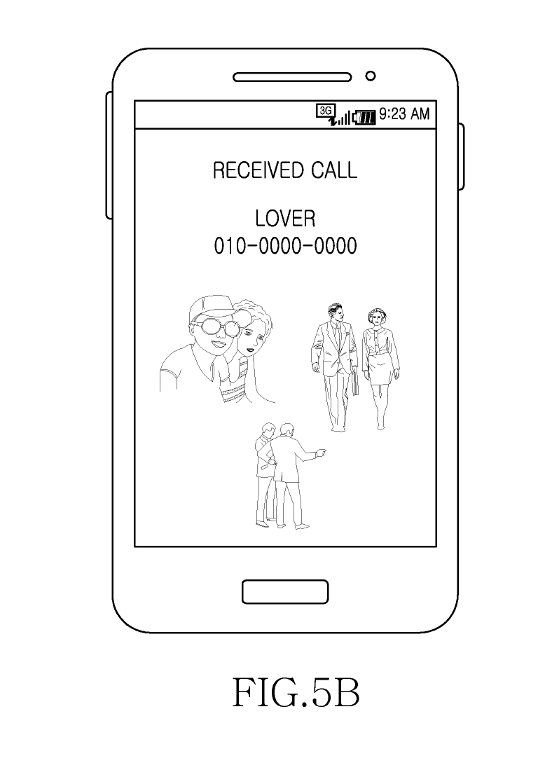

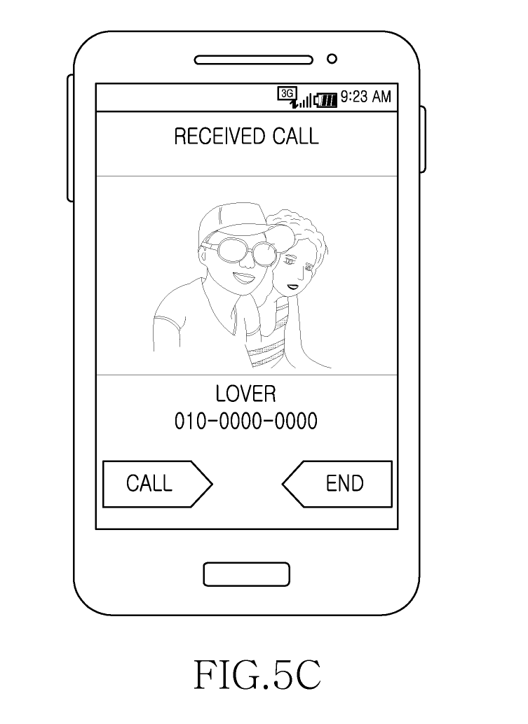

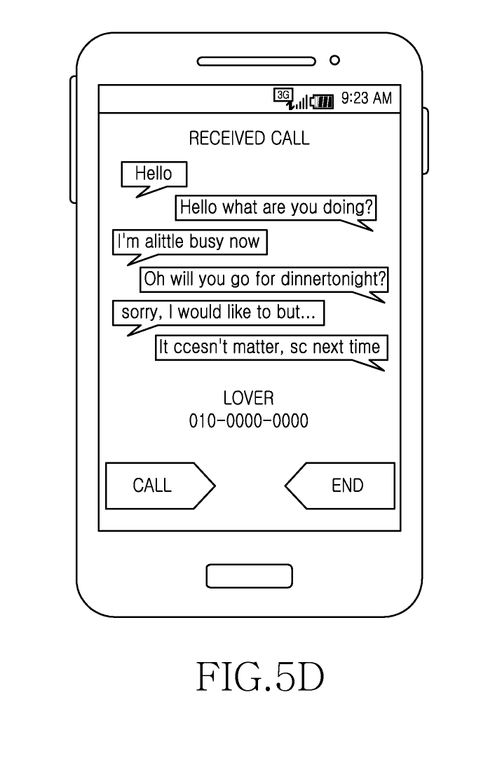

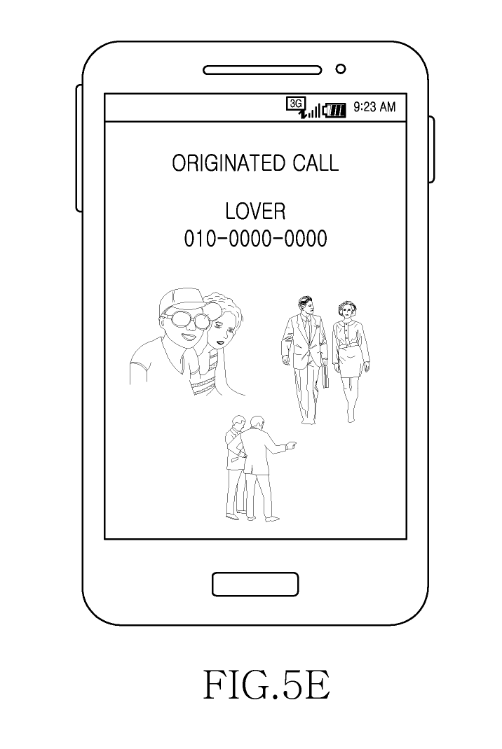

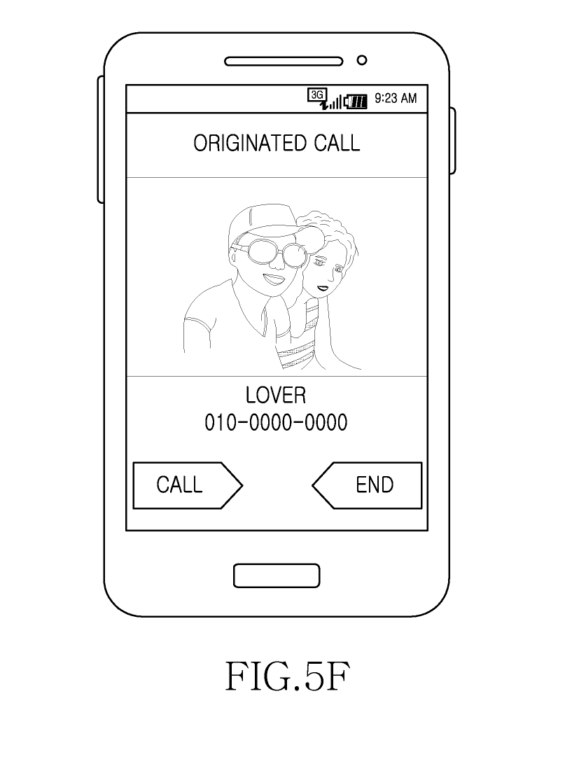

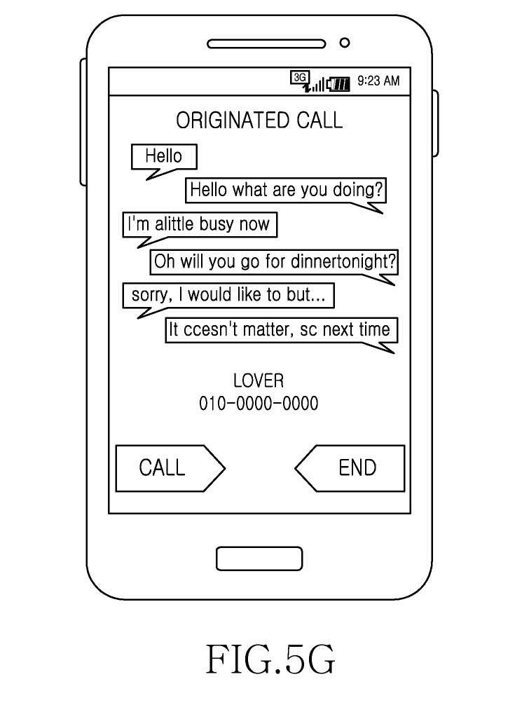

The sympathy information control program 115 includes at least one software element for outputting sympathy information according to a sympathy event. For example, when a call is received, the sympathy information control program 115, may retrieve sympathy information on a call originator for outputting the sympathy information as call reception information, as illustrated in FIGS. 5B to 5D.

As another example, when a call is originated, the sympathy information control program 115 may retrieve sympathy information on a receiver for outputting the sympathy information as call origination information, as illustrated in FIGS. 5E to 5G.

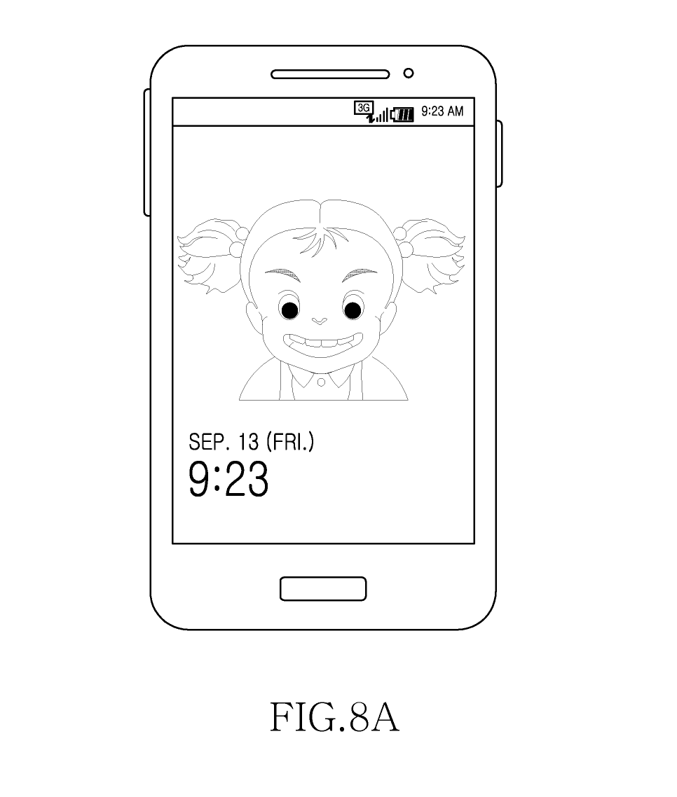

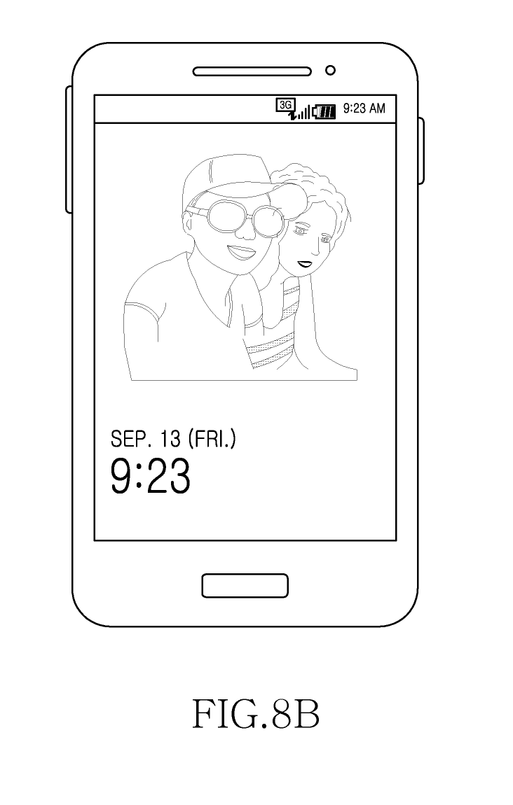

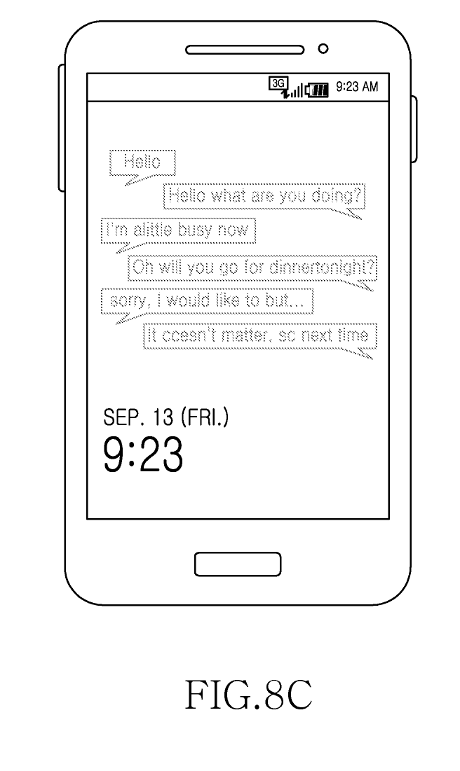

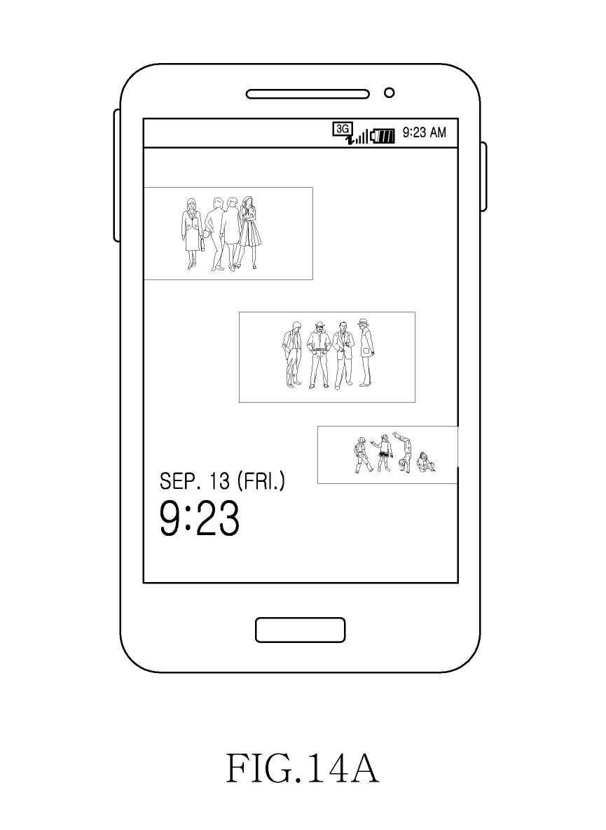

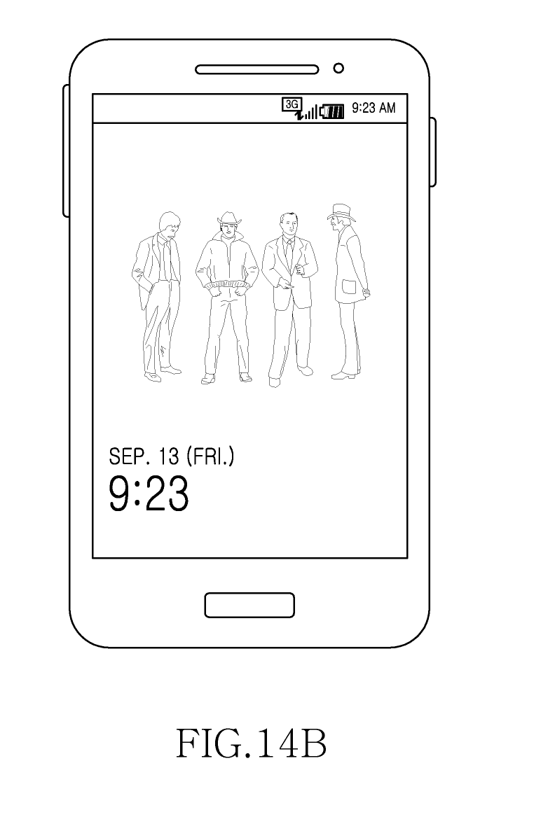

As another example, when a neighboring sympathy terminal is identified, the sympathy information control program 115 may confirm sympathy information on a sympathy terminal for outputting the sympathy information as a lock screen or a background screen, as illustrated in FIGS. 8A to 8C. Alternatively, the sympathy information control program 115 may select a group image of 3 or more persons as a sympathy image, as illustrated in FIGS. 14A and 14B.

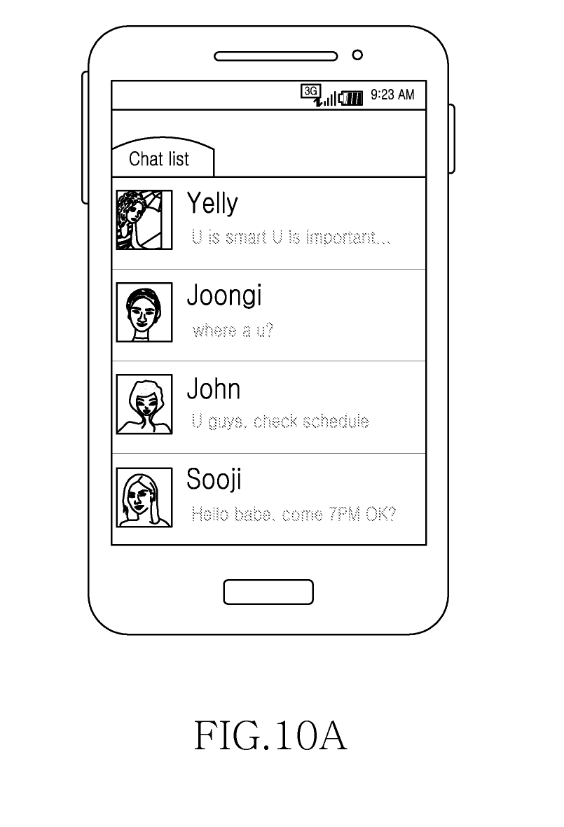

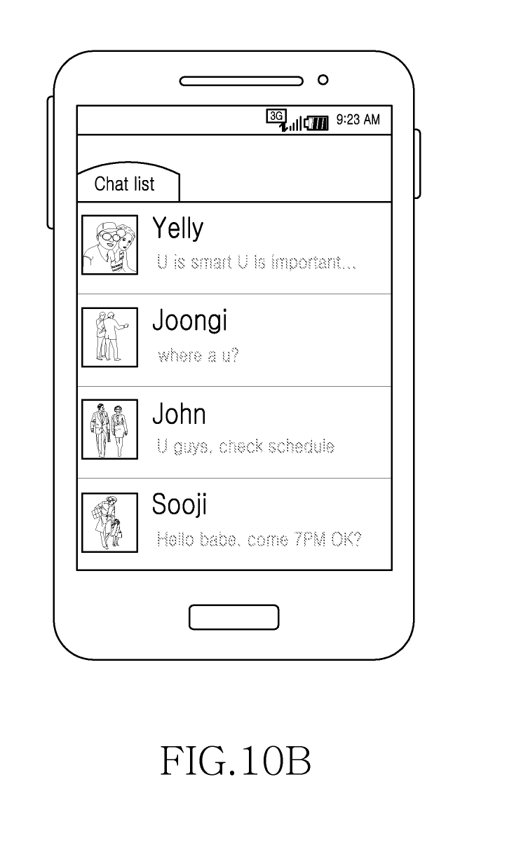

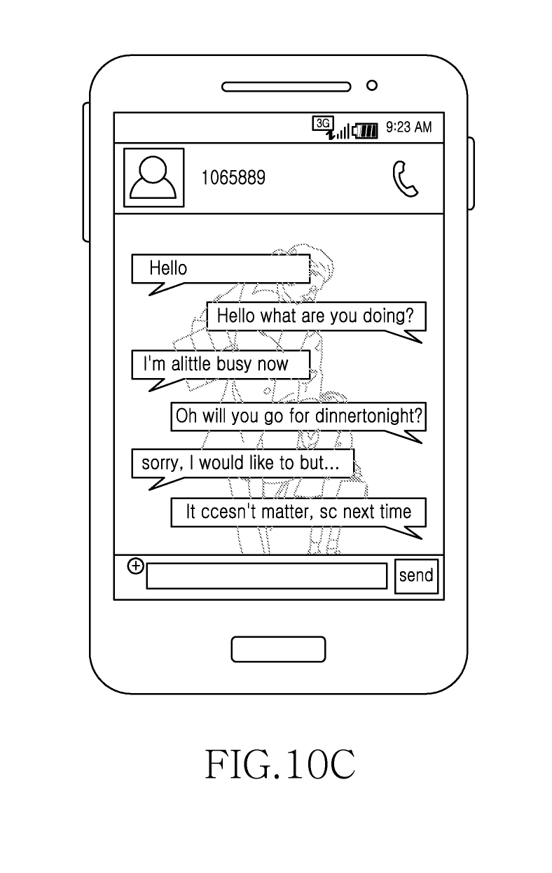

As another example, when a sympathy event is generated, the sympathy information control program 115 may retrieve sympathy information on an opposite party to each conversation for setting the sympathy information as profile images in a messenger address book, as illustrated in FIGS. 10A and 10B.

As another example, when a sympathy event is generated, the sympathy information control program 115 may retrieve sympathy information on an opposite party of a conversation for setting the sympathy information as a background screen of a messenger, as illustrated in FIG. 10C.

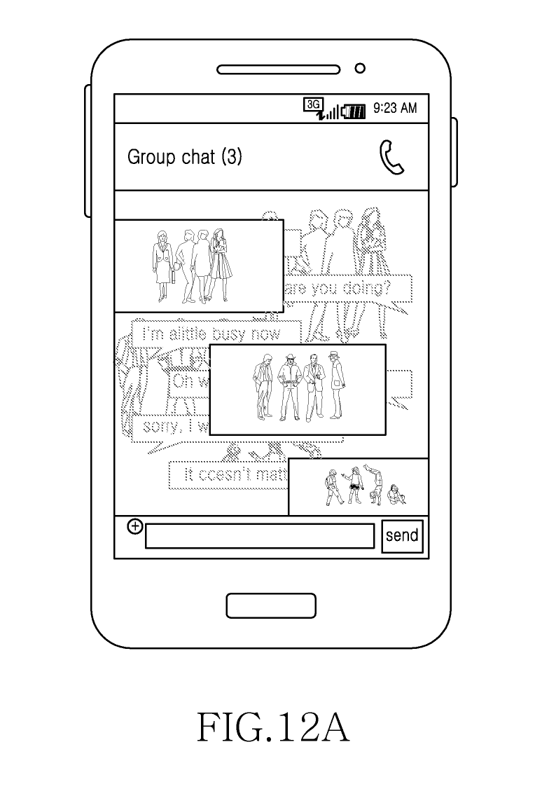

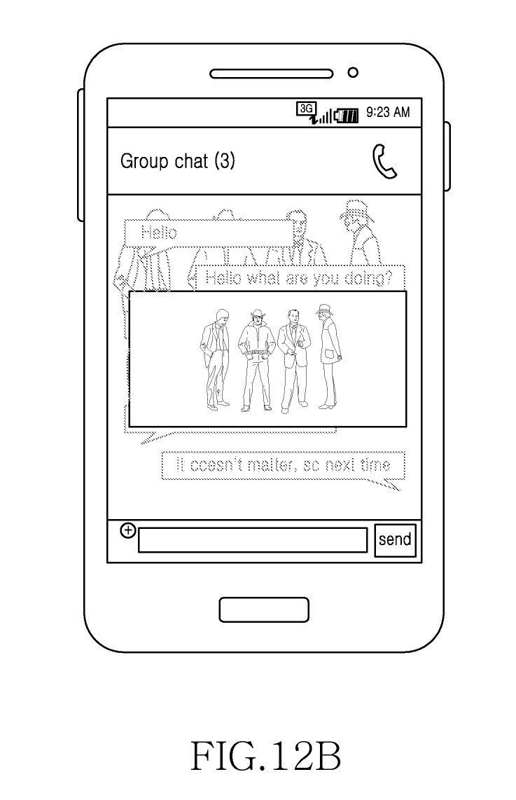

As another example, when a user talks with a plurality of conversation opposite parties through a messenger application program, e.g., performs a group chat, the sympathy information control program 115 may select a group image of 3 or more persons as a sympathy image, as illustrated in FIGS. 12A and 12B.

Herein, a sympathy terminal may include an opposite party terminal that the electronic device 100 includes sympathy information about. The messenger address book may include a list of friends included in a messenger.

The application program 116 includes a software element for at least one application program installed in the electronic device 100.

The processor unit 120 includes a memory interface 121, at least one processor 122, and a peripheral device interface 123. Here, the memory interface 121, the at least one processor 122, and the peripheral device interface 123 included in the processor unit 120 may be integrated into at least one integrated circuit or separate configuration elements.

The memory interface 121 controls access of an element, such as the processor 122 or the peripheral device interface 124, to the memory 110.

The peripheral device interface 124 controls connection of the input and output peripheral device of the electronic device 100 with the processor 122 and the memory interface 121.

The processor 122 controls the electronic device 100 to provide various multimedia services using at least one software program. The processor 122 controls a corresponding service to be provided by executing at least one program stored in the memory 110.

The audio processing unit 130 provides an audio interface between a user and the electronic device through a speaker 131 and a microphone 132.

The camera unit 140 provides images collected by capturing a subject using a camera lens. For example, the camera unit 140 may include a camera sensor converting an optical signal into an electrical signal, an image processor for converting an analog image signal into a digital image signal, and a signal processor for image-processing and allowing the image signal output from the image processor to be displayed on the display unit 170. Here, the camera sensor may include a Charge-Coupled Device (CCD) or a Complementary Metal-Oxide-Semiconductor (CMOS) sensor, and the signal processor may include a Digital Signal Processor (DSP).

The input and output controller 150 provides an interface between an input and output device, such as the display unit 160 and the input device 170 and the peripheral device interface 124.

The display unit 160 displays state information of the electronic device 100, letters input by a user, moving pictures, still images, etc. For example, the display 160 may display application information driven by the processor 122. As another example, the display unit 160 may display the sympathy information determined by the sympathy information control program 114.

Additionally, when the display unit 150 is configured as a touch screen, the display unit 160 further includes a touch input unit, which provides touch information sensed through a touch panel to the processor unit 120 through the input and output controller 150. The touch input unit provides touch information output from a touch pen or a finger to the processor unit 120 through the input and output controller 150.

The input device 170 provides input data created by a user selection to the processor unit 120 through the input and output controller 150. For example, the input device 170 may include at least one of a control button for controlling the electronic device 100 and a key pad for receiving input data from a user.

Although not illustrated in the drawing, the electronic device 100 may further include a Radio Frequency (RF) system for performing a communication function for voice and data communication. The RF system includes a plurality of sub-modules for wireless communication, such as an antenna, a transmitter, and receiver, and an RF module. Further, the RF system may be divided into a plurality of communication sub-modules supporting different communication networks. For example, the communication network includes, but is not limited to, a Global System for Mobile communications (GSM) network, an Enhanced Data for Global Evolution (EDGE) network, a Code-Division Multiple Access (CDMA) network, a Wideband-CDMA (W-CDMA) network, a Long Term Evolution (LTE) network, an Orthogonal Frequency-Division Multiple Access (OFDMA) network, a wireless Local Area Network (LAN), a Bluetooth network, a Near Field Communication (NFC) network, etc.

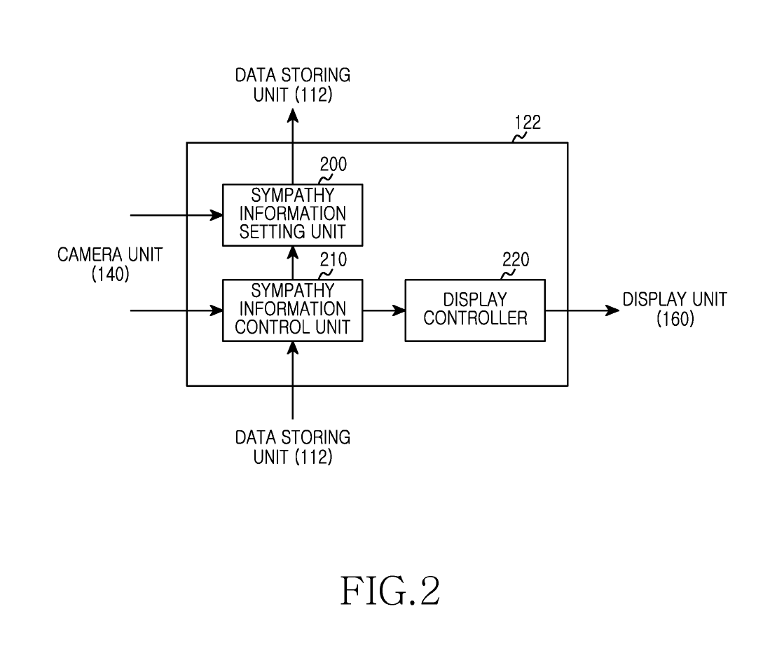

In FIG. 1, the processor 122 may set the sympathy information by executing software elements stored in the program storing unit 111 in a single module, and control to output the sympathy information according to a sympathy event. However, in accordance with another embodiment, as will be described with reference to FIG. 2 below, the processor 122 may also set sympathy information and may be configured to include, as separate modules, configuration elements for controlling to output the sympathy information according to the sympathy event.

FIG. 2 illustrates a processor according to an embodiment of the present invention.

Referring to FIG. 2, the processor 122 includes a sympathy information setting unit 200, a sympathy information controller 210, and a display controller 220.

The sympathy information setting unit 200 sets sympathy information. For example, the sympathy information setting unit 200 sets sympathy information by executing the sympathy information setting program 114 stored in the program storing unit 111. The sympathy information setting unit 200 retrieves sympathy information set by a user according to a sympathy information setting event. As another example, the sympathy information setting unit 200 may extract sympathy images through face recognition for an image provided through the camera unit 140 or a network, as illustrated in FIG. 6.

As another example, the sympathy information setting unit 200 may create sympathy information in consideration of user scheduling information. For example, when a user sets scheduling information to watch a movie with friends, the sympathy information setting unit 200 may create sympathy information for the friends based on information of the movie.

The sympathy information setting unit 200 stores the sympathy information to the data storing unit 112.

The sympathy information controller 210 determines the sympathy information to be output. For example, the sympathy information controller 210 executes the sympathy information control program 115 stored in the program storing unit 111 to determine the sympathy information to be output. When a call is received, the sympathy information controller 210 may retrieve sympathy information on a call originator, which is to be output as call reception information, as illustrated in FIGS. 5B to 5D.

As another example, when a call is originated, the sympathy information controller 210 may retrieve sympathy information on a receiver, which is to be output as call origination information, as illustrated in FIGS. 5E to 5G.

As another example, when a neighboring sympathy terminal is identified, the sympathy information controller 210 may also retrieve sympathy information on the neighboring sympathy terminal to set as a lock screen or a background screen, as illustrated in FIGS. 8A to 8C. Alternatively, the sympathy information controller 210 may also select a group image of 3 or more persons as the sympathy image, as illustrated in FIGS. 14A and 14B.

As another example, when a sympathy event occurs, the sympathy information controller 210 may retrieve sympathy information on an opposite party of a conversation for setting the sympathy information as a profile image in a messenger address book, as illustrated in FIGS. 10A and 10B.

As another example, when a sympathy event occurs, the sympathy information controller 21 may retrieve the sympathy information on an opposite party of the conversation for setting the sympathy information as a background image of a messenger, as illustrated in FIG. 10C.

As another example, when conversation is performed among a plurality of opposite parties through a messenger application program, the sympathy information controller 210 may select a group image of 3 or more persons as a sympathy image, as illustrated in FIGS. 12A and 12B.

The display controller 220 executes the GUI program 113 stored in the program storing unit 112 and controls to graphically display a user interface on the display unit 160. For example, the display controller 220 controls to display information on an application program driven by an application program driving unit on the display unit 170.

As another example, the display controller 220 may control to display the sympathy information determined by the sympathy information controller 220 on the display unit 160.

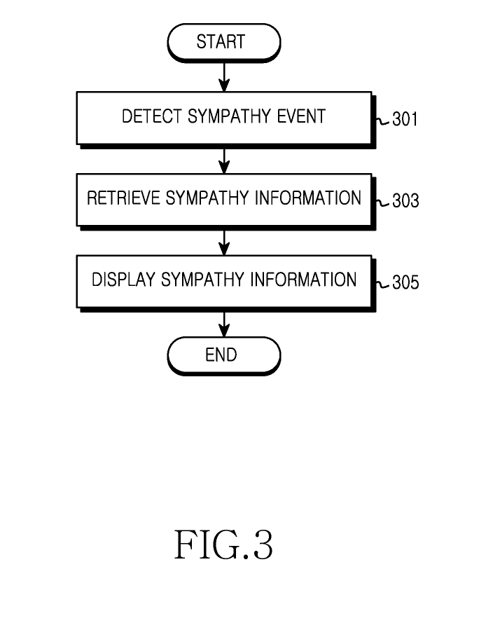

FIG. 3 is a flowchart illustrating a procedure for outputting sympathy information in an electronic device according to an embodiment of the present invention.

Referring to FIG. 3, the electronic device detects an occurrence of a sympathy event in step 301. For example, the electronic device detects that a call is received or a call originating event occurs, while a sympathy mode is set in the electronic device. That is, the electronic device may detect that a specific terminal is calling or has been selected to call by a user manipulation.

As another example, when operating in a sympathy mode, the electronic device may identify that a neighboring sympathy terminal exists or may detect that a messenger application program is executed.

In step 303, the electronic device retrieves sympathy information according to the detected sympathy event. For example, when a call is received, the electronic device may retrieve sympathy information matched with a call originator, or when a call is made from the electronic device, the electronic device may retrieve sympathy information matched with a call receiver. As another example, when a neighboring sympathy terminal exists, the electronic device may retrieve sympathy information corresponding to the neighboring sympathy terminal. As another example, when a messenger program is executed, the electronic device may retrieve sympathy information matched with an opposite party of each conversation included in the messenger address book. As another example, when conversation with a specific opposite party is performed through a messenger application program, the electronic device may retrieve sympathy information matched with the conversation opposite party.

After retrieving the sympathy information, in step 305, the electronic device outputs, e.g., displays, sympathy information according to the sympathy event. For example, the electronic device may display call reception or call origination by using a sympathy image, may change a background image by using the sympathy image, may change profile photos in a messenger address book by using the sympathy images, may set the sympathy image as a background image of a messenger conversation window., or may set a lock screen or a background screen by using the sympathy image.

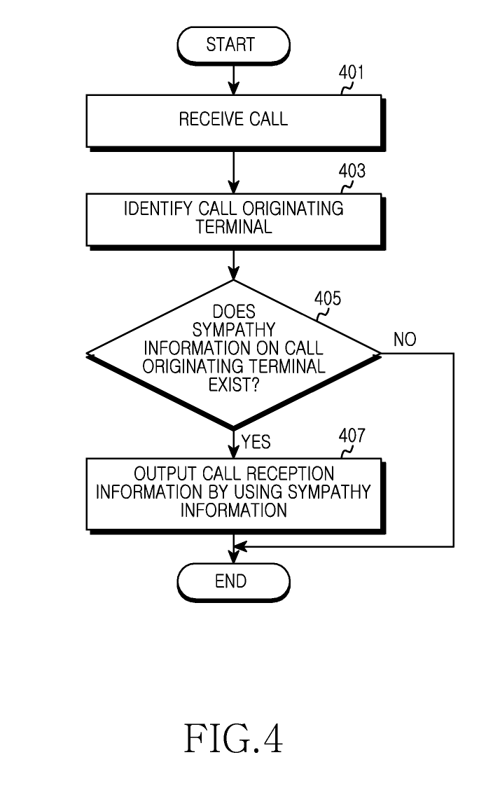

FIG. 4 is a flowchart illustrating a procedure for outputting sympathy information about an originating terminal in an electronic device according to an embodiment of the present invention. In the description below, the electronic device is set in a sympathy mode.

Referring to FIG. 4, in step 401, the electronic device receives an incoming call.

In step 403, the electronic device identifies a call originating terminal. For example, the electronic device may receive identification information on the call originating terminal, such as a phone number.

In step 405, the electronic device determines if sympathy information exists for the originating terminal. For example, the electronic device determines if sympathy information, matched with the originating terminal (e.g., matched with the phone number of the call originating terminal), is included among a plurality of pieces of pre-stored sympathy information.

When the sympathy information on the originating terminal does not exist, the procedure ends. For example, the electronic device may display call reception information by using a default call reception image.

However, when sympathy information for the originating terminal exists, in step 407, the electronic device displays call reception information using the sympathy information for the originating terminal. For example, when a call is received in a waiting state, as illustrated in FIG. 5A, the electronic device displays the call reception information using a sympathy image for the originating terminal, as illustrated in FIG. 5C.

As another example, when there are a number of sympathy images for the originating terminal, the electronic device may display the sympathy images, as illustrated in FIG. 5B, in order for a user to select sympathy images to be used as the call reception information. When at least one sympathy image is selected from among the plurality of displayed sympathy images, the electronic device may then display the selected sympathy image as call reception information, as illustrated in FIG. 5C.

When the sympathy image to be used as the call reception information is not selected within a reference time, the electronic device may select at least one sympathy image according to a priority set to the sympathy images and display the selected sympathy image as the call reception information. For example, the priority of the sympathy images may be determined based on the number of times the sympathy images have been selected, or creation times of the sympathy images, e.g., picking the newest image.

As another example, when a call is received in a waiting state, as illustrated in FIG. 5A, the electronic device may extract messenger conversation content with the originating terminal and display the extracted content as the call reception information, as illustrated in FIG. 5D.

As described above, when a call is received, the electronic device may display the call reception information using sympathy information for the originating terminal.

In accordance with another embodiment of the present invention, when a call originating event occurs, i.e., when a call is made from the electronic device, the electronic device may display the call reception information using sympathy information for the originating terminal, which corresponds to call origination. For example, when a call originating event occurs in a waiting state, as illustrated in FIG. 5A, the electronic device may display call origination information as a sympathy image for a receiving terminal.

As another example, when there are multiple sympathy images for the receiving terminal, the electronic device may display the sympathy images for the receiving terminal, as illustrated in FIG. 5E. Again, when at least one sympathy image is selected from among the plurality of displayed sympathy images, the electronic device may then display the selected sympathy image as the call origination information, as illustrated in FIG. 5F.

Further, when the sympathy image to be used as the call origination information is not selected within a reference time, the electronic device may select at least one sympathy image according to a priority set to the sympathy images to display the selected sympathy image as the call origination information. For example, the priority of the sympathy images may be based on the numbers of selection times of the sympathy images, or creation times of the sympathy images.

As another example, when a call originating event occurs in the waiting state, as illustrated in FIG. 5A, the electronic device may extract messenger conversation content with the reception terminal and display the extracted content as the call origination information, as illustrated in FIG. 5G.

As described above, the electronic device may display the call origination information or the call reception information by using the sympathy image matched with the originating terminal or the receiving terminal.

FIG. 6 is a flowchart illustrating a procedure for generating a sympathy image in an electronic device according to an embodiment of the present invention.

Referring to FIG. 6, the electronic device detects an image in step 601. For example, the electronic device may detect that a photo is captured through the camera unit 140 or that an image is received through a network.

In step 603, the electronic device determines if the image includes sympathy information. For example, the electronic device may determine a number of persons included in the image through face recognition, and when the number of persons included in the image is two, the electronic device may perceive the image to include sympathy information. Here, the number of persons included in the image may by more than two.

When the image does not include sympathy information in step 603, the procedure ends.

When the image includes the sympathy information in step 603, the electronic device determines if the image includes first personal information in step 605. For example, the electronic device retrieves face features of a first person in a reference image of the first person. Then, the electronic device confirms that the image detected in operation 601 includes the first personal information, based on the retrieved face features for the first person. Here, the first person may be an owner of the electronic device or an owner of an account set for a specific service of the electronic device. The reference image may include a profile image of the first person or a preset photo of the first person.

When an image does not include the first personal information in step 605, the electronic device perceives that an image to be set as the sympathy image does not exist and the procedure ends.

When the image includes the first personal information in step 605, the electronic device identifies second personal information from the image in step 607. For example, the electronic device retrieves face features of the opposite party using a profile image shared over a social network and then identifies the second personal information included in the image detected in operation 601, based on the face features of the opposite party. For example, the electronic device may collect face features of the opposite party through a face recognition application program.

After the second personal information is identified, the electronic device sets the image detected in operation 601 as a sympathy image for the second person in step 609. The electronic device may tag the sympathy image information on the second person to the image detected in operation 601 or store the image to a separate storage space for the second person.

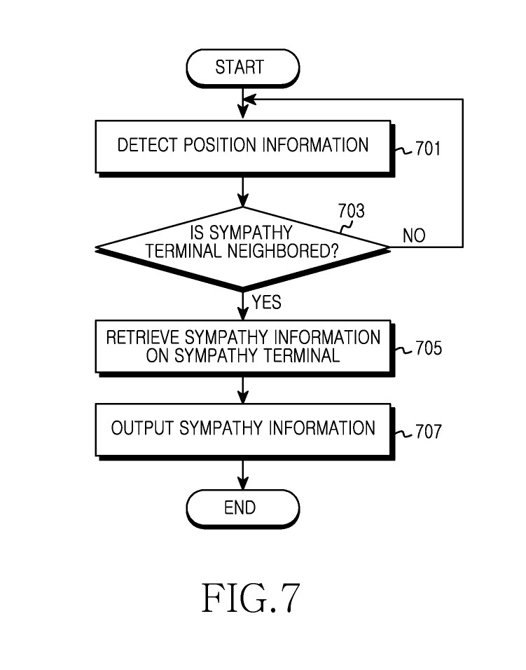

FIG. 7 is a flowchart illustrating a procedure for outputting sympathy information based on position information in an electronic device according to an embodiment of the present invention. In FIG. 7, the electronic device is already operating in a sympathy mode.

Referring to FIG. 7, the electronic device detects the position information of the electronic device in operation 701.

In step 703, the electronic device determines if a neighboring sympathy terminal exists. For example, the electronic device may detect that the neighboring terminal exist using position information of the sympathy terminals provided from a sympathy service server, or using position information of sympathy terminals registered in a social network. Here, a sympathy terminal may include an opposite party terminal that the electronic device includes sympathy information for.

When a neighboring sympathy terminal does not exist in step 703, the electronic device re-confirms its own position information in step 701.

When the neighboring sympathy terminal exists in step 703, the electronic device retrieves sympathy information for a neighboring sympathy terminal in step 705.

In step 707, the electronic device outputs the retrieved sympathy information on the neighboring sympathy terminal.

For example, as illustrated in FIG. 8A, when the neighboring sympathy terminal is detected in a lock screen state, the electronic device may change the lock screen to a sympathy image on the neighboring sympathy terminal, as illustrated in FIG. 8B.

As another example, when there are multiple sympathy images associated with the neighboring terminal, the electronic device may display the sympathy images for the sympathy terminal in order for a user to select a sympathy image to be set as the lock screen. When at least one sympathy image is selected from among the plurality of displayed sympathy images, the electronic device changes the lock screen to the selected sympathy image, as illustrated in FIG. 8B. Further, when a sympathy image to be set as the lock screen is not selected within a reference time, the electronic device may select at least one sympathy image according to a priority set to the sympathy images and change the lock screen to the selected sympathy image. As described above, the priority of the sympathy images may be determined based on the number of selection times of the sympathy images, or creation times of the sympathy images.

As another example, when a neighboring sympathy terminal is detected in the lock screen as illustrated in FIG. 8A, the electronic device may extract a messenger conversation content with the sympathy terminal and display the extracted content as call reception information, as illustrated in FIG. 8C.

As described above, the electronic device may set the sympathy information associated with the neighboring sympathy terminal as a lock screen.

In accordance with another embodiment of the present invention, the electronic device may set the sympathy information associated with the neighboring sympathy terminal as a background screen.

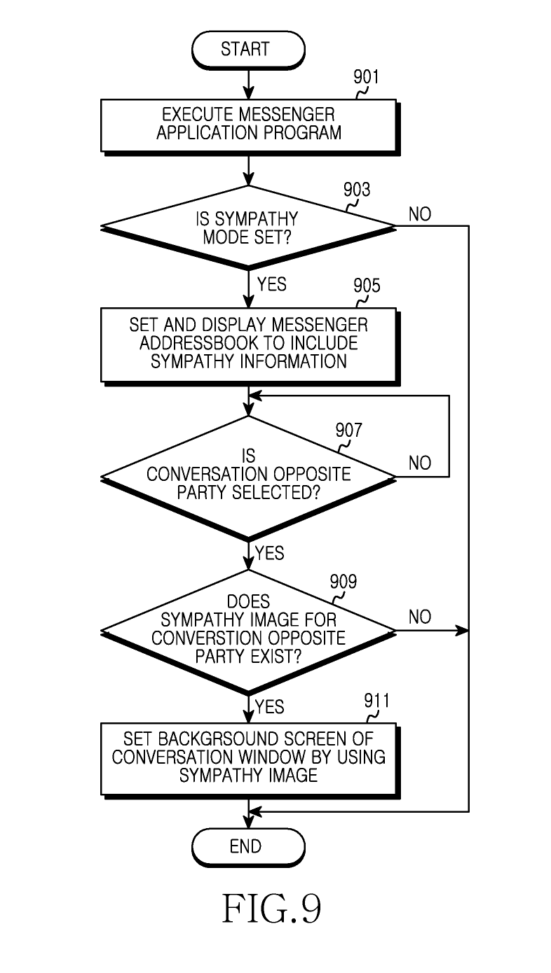

FIG. 9 is a flowchart illustrating a procedure for outputting sympathy information through a messenger application program in an electronic device according to an embodiment of the present invention.

Referring FIG. 9, the electronic device executes the messenger application program in step 901. For example, when a user selects the messenger application program, the electronic device may execute the corresponding messenger application program.

In step 903, the electronic device determines if a sympathy mode is set.

When the sympathy mode is not set, the procedure ends. For example, when the sympathy mode is not set, the electronic device may display a profile image of an opposite party of each conversation in the messenger address book, as illustrated in FIG. 10A.

When the sympathy mode is set in step 903, the electronic device sets profile images presented in a messenger address book as sympathy images, and then displays the sympathy images in step 905. For example, the electronic device may change the profile image in the messenger address book to a sympathy image, as illustrated in FIG. 10B.

In step 907, the electronic device determines if an opposite party is selected for a conversation. For example, the electronic device may determine if a specific conversation opposite party is selected in the messenger address book, as illustrated in FIG. 10A or 10B.

When the opposite party for the conversation is selected in step 907, the electronic device determines if a sympathy image for the opposite party exists in step 909.

When the sympathy image for the opposite party does not exist in step 909, the procedure ends.

However, when the sympathy image for the opposite party exists in step 909, the electronic device proceeds sets the sympathy image for the conversation opposite party as a background image of a conversation window in step 911. For example, as illustrated in FIG. 10C, the electronic device may set the sympathy image for the conversation opposite party as a background image of the conversation window and display the background image.

As described above, the electronic device may set multiple images including first personal information as a sympathy image.

In accordance with another embodiment of the present invention, the electronic device may set a group image including the first personal information as a sympathy image. In this case, the electronic device may perceive a sympathy image for a sympathy event including the same personal information as personal information according to the sympathy event.

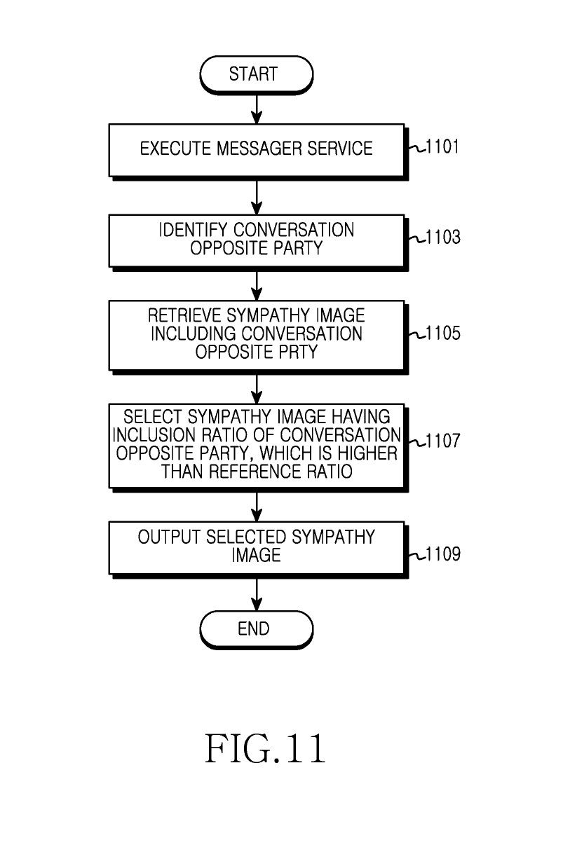

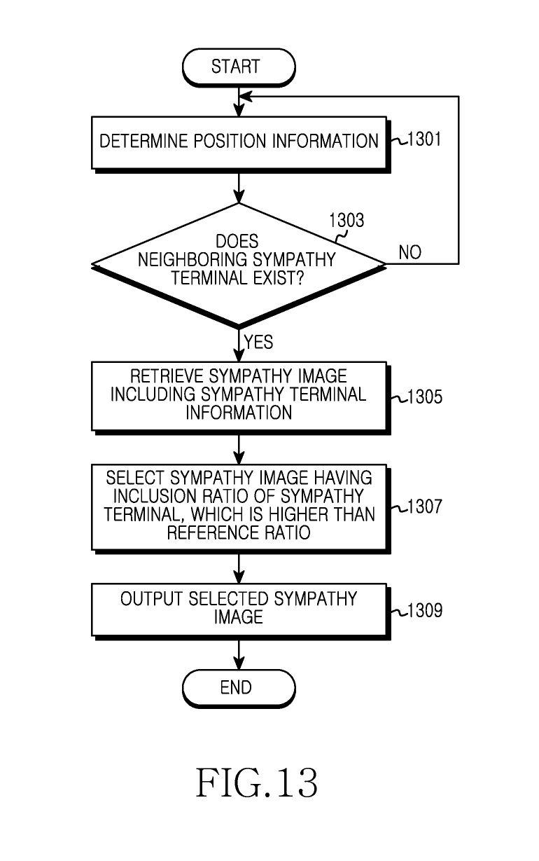

As another example, as illustrated in FIGS. 11 and 13, when a ratio of inclusion of a sympathy terminal in a sympathy image including a plurality of persons is greater than a reference ratio, the electronic device may perceive the sympathy image including the plurality of persons as a sympathy image for the corresponding sympathy event.

FIG. 11 illustrates a procedure for outputting sympathy information through a messenger application program according to an embodiment of the present invention. In FIG. 11, the electronic device is already operating in a sympathy mode.

Referring to FIG. 11, the electronic device executes a messenger application program in step 1101.

In step 1103, the electronic device identifies an opposite party for a conversation over a messenger.

In step 1105, the electronic device retrieves a sympathy image including the identified opposite party. When there are multiple opposite parties, e.g., during a group conversation, the electronic device retrieves all sympathy images including at least one of the opposite parties.

After retrieving the sympathy images, the electronic device selects sympathy images having inclusion ratios of the opposite party, which are higher than a reference ratio, from among the sympathy images including the at least one of opposite parties in step 1107.

In step 1109, the electronic device outputs the sympathy images selected in steps 1107. For example, as illustrated in FIG. 12A, the electronic device may set the sympathy images having inclusion ratios of the opposite party, which are higher than the reference ratio, as background images of conversation windows.

As another example, as illustrated in FIG. 12B, the electronic device may set a sympathy image having a highest ratio of inclusion of the opposite parties as a background image of conversation windows.

As described above, the electronic device may output sympathy images having inclusion ratios of the opposite parties, which are higher than a reference ratio or may output a sympathy image having the highest ratio of inclusion of the conversation opposite parties.

FIG. 13 is a flow chart illustrating a procedure for outputting sympathy information based on position information in an electronic device according to an embodiment of the present invention.

Referring to FIG. 13, the electronic device determines its own position information in step 1301.

In step 1303, the electronic device determines of a neighboring sympathy terminal exists using position information on at least one sympathy terminal. For example, the electronic device may detect that a neighboring terminal exists using the position information on the sympathy terminals, which is provided from a sympathy service server managing the position information of the sympathy terminals or using position information on sympathy terminals registered to a social network.

When a neighboring sympathy terminal does not exist in step 1303, the electronic device re-determines its own position information in step 1301.

However, when the neighboring sympathy terminal exists in step 1303, the electronic device retrieves a sympathy image associated with the neighboring sympathy terminal, e.g., that includes a user of the neighboring sympathy terminal, in step 1305. When multiple images are associated with the neighboring sympathy terminal, the electronic device retrieves all of these sympathy images.

In step 1307, the electronic device selects sympathy images having inclusion ratios of opposite parties, which are higher than a reference ratio from among sympathy images associated with at least one sympathy terminal.

In step 1309, the electronic device outputs sympathy images selected in operation 1307.

For example, as illustrated in FIG. 14A, the electronic device may set the sympathy images having inclusion ratios of users of the sympathy terminals, which are higher than a reference ratio, as lock screens. As another example, as illustrated in FIG. 14B, the electronic device may set a sympathy image having the highest ratio of inclusion of users of the sympathy terminals as the lock screen.

As described above, the electronic device may output sympathy images having inclusion ratios of users of sympathy terminals, which are higher than a reference ratio. Alternatively, the electronic device may output sympathy images associated with at least one of the sympathy terminals.

As described above, the electronic device may set sympathy information associated with a neighboring sympathy terminal as a lock screen or as a background screen.

As described above, an electronic device can provide an emotional user interface for smooth communication between a user and an opposite party by providing sympathy information for forming a bond of sympathy with other persons. Here, the sympathy information includes at least one of an image, text, and content that is stored as shared information by a user of the electronic device with a user of the opposite party terminal

It will be appreciated that embodiments of the present invention according to the claims and description in the specification can be realized in the form of hardware, or a combination of hardware and software. Any such software may be stored in a non-transient computer readable storage medium. The non-transient computer readable storage medium stores one or more programs (software modules), the one or more programs including instructions, which when executed by one or more processors in an electronic device, cause the electronic device to perform a method of the present invention. Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disc (CD), a Digital Versatile Disc (DVD), magnetic disk, magnetic tape, etc. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present invention has been shown and described with reference to certain embodiments thereof, it will be understood by those skilled in the art that various changes in form and details may be made therein without departing from the spirit and scope of the invention as defined by the appended claims.

What is claimed is:

1. A method of outputting sympathy information in an electronic device, the method comprising:
detecting a event associated with an opposite party terminal;
retrieving sympathy information associated with the opposite party terminal; and
outputting the sympathy information,
wherein the sympathy information includes at least one of an image, text, and content that is stored as shared information by a user of the electronic device with a user of the opposite party terminal.

2. The method of claim 1, wherein the event includes a call being received from the opposite party terminal.

3. The method of claim 2, wherein outputting the sympathy information comprises displaying the sympathy information as call reception information.

4. The method of claim 1, wherein the event includes calling the opposite party terminal.

5. The method of claim 4, wherein outputting the sympathy information comprises displaying the sympathy information as call origination information.

6. The method of claim 1, wherein the sympathy information includes images including a plurality of persons, and
wherein retrieving the sympathy information comprises selecting an image including the user of the opposite party terminal from among the image included in the sympathy information.

7. The method of claim 6, wherein selecting the image comprises selecting an image that has an inclusion ratio for the user of the opposite party terminal, which is higher than a reference ratio, from among the image included in sympathy information.

8. The method of claim 1, wherein outputting the sympathy information comprises displaying the sympathy information as at least one of a lock screen and a background screen.

9. The method of claim 1, wherein outputting the sympathy information comprises displaying the sympathy information as a profile image of the opposite party terminal in a messenger.

10. The method of claim 1, wherein outputting the sympathy information comprises displaying the sympathy information as a background image of a messenger conversation window.

11. An electronic device outputting sympathy information, the electronic device comprising:
a display unit; and
a processor configured to detect an event associated with an opposite party terminal, retrieve sympathy information associated with the opposite party terminal, and output the sympathy information through the display unit,
wherein the sympathy information includes at least one of an image, text, and content that is stored shared information by a user of the electronic device with a user of the opposite party terminal.

12. The electronic device of claim 11, wherein the event comprises a call being received from the opposite party terminal.

13. The electronic device of claim 12, wherein the display unit displays the sympathy information as call reception information.

14. The electronic device of claim 11, wherein the event comprises a call being made to the opposite party terminal.

15. The electronic device of claim 14, wherein the display unit displays the sympathy information as call origination information.

16. The electronic device of claim 11, wherein the sympathy information comprises images including a plurality of persons, and
wherein the processor selects an image including the user of the opposite party terminal from among the images as the sympathy information.

17. The electronic device of claim 16, wherein the processor selects the image having an inclusion ratio for the user of the opposite party terminal, which is higher than a reference ratio, from among the images.

18. The electronic device of claim 11, wherein the display unit displays the sympathy information as at least one of a lock screen and a background screen.

19. The electronic device of claim 11, wherein the display unit displays the sympathy information as a profile image of the user of the opposite party terminal in a messenger.

20. The electronic device of claim 11, wherein the display unit displays the sympathy information as a background screen of a messenger conversation window.
